(19) United States
(12) Patent Application Publication
(10) Pub. No.: US 2007/0050491 A1
(43) Pub. Date: Mar. 1, 2007

(54) Cache system

(76) Inventors: Mikio Kataoka, Kokubunji (JP); Kunihiko Toumura, Hachioji (JP); Toshiaki Suzuki, Hachioji (JP); Hideki Okita, Kokubunji (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/489,666

(22) Filed: Jul. 20, 2006

(30) Foreign Application Priority Data
Sep. 1, 2005 (JP) 2005-253429

(51) Int. Cl. G06F 15/173

(52) U.S. Cl. 709/223

(57) ABSTRACT

The purpose of the invention is to provide a distributed cache system applicable to a large-scale network having multiple cache servers. In a distributed cache system including multiple cache control servers, the content information is divided and managed by each cache control server. When content requested from a client is stored in the distributed cache system, a cache cooperation router forwards the content request to the cache control server which manages the information of the requested content. A cache control server has a function to notify its own address to the distributed cache system when the cache control server is added to the distributed cache system. When a cache control server receives the notification, it sends content information to the new cache control server and synchronizes the content information. Thus, a cache control server can be added to the system with ease.

### CLAIM OF PRIORITY

The present application claims priority from Japanese patent application JP 2005-253429 filed on Sep. 1, 2005, the content of which is hereby incorporated by reference into this application.

### FIELD OF THE INVENTION

The invention relates to a distributed cache system in which multiple cache servers are deployed in a network. Particularly, the invention relates to a technology to provide content through cooperation between multiple cache servers.

### BACKGROUND OF THE INVENTION

In a network where multiple clients are connected, a cache server can be provided to send content from the cache server to the clients in case that two or more clients refer to one content, in order to reduce the frequency of content acquisition from external networks. By this means, the traffic between networks can be reduced, thus the communication cost can be cut.

However, in a large-scale network, heavy traffic may occur because a lot of requests from clients. It is difficult for one cache server to accommodate heavy traffic occurring in the network. In order to solve this problem, multiple cache servers can be deployed in a network to send content from cache servers to the client.

A distributed cache system is proposed which can reduce traffic between networks wherein when the cache server does not store the content requested by a client, the content is acquired from another cache server which stores the requested content, and sent to the client that requested the content.

### SUMMARY OF THE INVENTION

The distributed cache system as above includes a cache control server and a cache cooperation router. Therefore, when the network expands with increased number of clients, the traffic occurring in the network may exceed the processing capacity of a cache control server and a cache cooperation router.

Therefore, it is necessary to construct a distributed cache system which can be adapted to a large-scale network comprising multiple cache control servers and multiple cache cooperation routers in the distributed cache system, in order to accommodate heavy traffic due to increased number of client requests.

There are several problems when constructing a distributed cache system comprising multiple cache control servers. First, when the content requested by a client is stored in the distributed cache system, the request from the client must be forwarded to the cache control server which manages the content.

Second, when the content requested by a client is stored in the distributed cache system, every cache cooperation router must forward the request to the cache control server which manages then content.

Third, it is necessary that a cache control server and a cache cooperation router can be added or removed from the network with ease.

Forth, in a distributed cache system applicable to a large-scale network, so many content are present in the distributed cache system that a large table is necessary for the cache cooperation router to determine whether the content is stored in the cache system. The larger the table is, the longer the search time will be.

In order to solve these problems, this invention provides a distributed cache system which can be easily adapted to a large-scale network, in which multiple cache servers distributed in the network cooperate with each other, and forward content between cache servers if needed.

According to a representative aspect of the invention, a cache system includes multiple cache servers which stores content to be requested form a client, multiple cache control servers which manages content information stored in the cache servers, and a cache cooperation router which determines whether the content requested from the client is stored or not in the cache system. The multiple cache control servers shares and manages the content information stored in the cache system. The cache cooperation router grasps the content information managed by the each cache control server. When the cache cooperation router receives a content request from the client, the cache cooperation router identifies the cache control server which manages the requested content information. The cache cooperation router forwards the request from the client to the identified cache control server.

According to a representative aspect of the invention, a distributed cache system optimal for the number of clients can be provided by adjusting the number of cache control servers and cache cooperation routers depending on the traffic generated by content requests from clients.

### BRIEF DESCRIPTION OF THE DRAWINGS

The present invention can be appreciated by the description which follows in conjunction with the following figures, wherein:

FIG. 1 is a drawing which shows a structure of a distributed cache system according to a first embodiment of the invention;

FIG. 2 is a drawing which shows a sequence of processes carried out by the distributed cache system according to the first embodiment;

FIG. 3 is a block diagram which shows a cache cooperation router according to the first embodiment;

FIG. 4 is a drawing which shows a structure of a cache hit determination table according to the first embodiment;

FIG. 5 is a flow chart which shows processes carried out by the cache cooperation router when it receives a content request according to the first embodiment;

FIG. 6 is a block diagram which shows a cache control server according to the first embodiment;

FIG. 7 is a drawing which shows a structure of a content information management table according to the first embodiment;

FIG. 8 is a flow chart which shows processes carried out by the cache control server when it receives a content request according to the first embodiment;

FIG. 9 is a flow chart which shows processes carried out by the cache control server when it receives content information from a cache server according to the first embodiment;

FIG. 10 is a block diagram which shows a cache server according to the first embodiment;

FIG. 11 is a flow chart which shows processes carried out by the cache server when it receives content according to the first embodiment;

FIG. 12 is a flow chart which shows processes carried out by the cache control server when it receives a content request according to a modified first embodiment;

FIG. 13 is a drawing which shows a structure of a distributed cache system according to a second embodiment;

FIG. 14 is a drawing which shows a sequence of processes carried out by a distributed cache system according to the second embodiment;

FIG. 15 is a drawing which shows a structure of a distributed cache system according to a third embodiment;

FIG. 16 is a drawing which shows a sequence of processes carried out by a distributed cache system according to the third embodiment;

FIG. 17 is a drawing which shows a structure of a cache hit determination table according to the third embodiment;

FIG. 18 is a flow chart which shows processes carried out by the cache cooperation router when it receives a content request from a client according to the third embodiment;

FIG. 19 is a block diagram which shows a system management server according to the third embodiment;

FIG. 20 is a diagram which shows a structure of a content information management table according to the third embodiment;

FIG. 21 is a flow chart which shows processes carried out by the system management server when it receives a content request according to the third embodiment; and

FIG. 22 is a flow chart which shows processes carried out by the system management server when it receives content information according to the third embodiment.

### DETAILED DESCRIPTION OF THE PREFERRED EMBODIMENT

According to one aspect of the invention, in order to solve the first problem as above, in a distributed cache system comprising multiple cache control servers, the content information stored in the distributed cache system is shared and managed by multiple cache control servers. When content requested by a client is stored in the distributed cache system, a cache cooperation router forwards the content request to the cache control server which manages the information of the requested content.

In order to solve the second problem, the cache control server receives new content information from a client, and sends the content information to all cache cooperation routers present in the distributed cache system.

In order to solve the third problem, when a cache control server or a cache cooperation router is added to the distributed cache system, the newly added server or router notifies its address to the distributed cache system. The cache control server receives the address notification, and sends the content information to the cache control server or the cache cooperation router newly added, to synchronize the content information.

In order to solve the fourth problem, the distributed cache system has a hierarchical structure in which the network is divided into domains, and the content information is managed for each domain. The cache cooperation router and the server which manages the content information of the whole distributed cache system divide the content information into domains and search in the domains at the time of search. This configuration improves the efficiency of the content search, and reduces the time necessary for replying to the content request from a client.

Next, the embodiments of the invention will be described with reference to the following drawings.

### First Embodiment

In a distributed cache system of a first embodiment, a distributed cache system which can be adapted to a large-scale network is provided in which cache control servers can be added when the content requests from clients increases, and the requests from clients are processed in a distributed manner by multiple cache control servers.

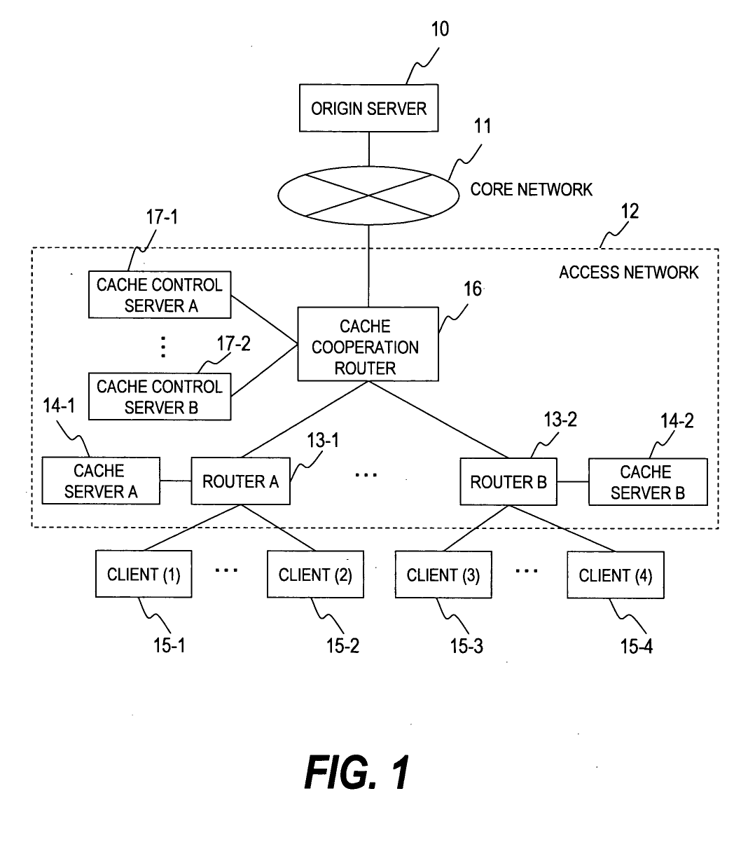

FIG. 1 is a block diagram which shows an exemplary structure of a distributed cache system according to the first embodiment of the invention.

The distributed cache system shown in FIG. 1 includes an origin server 10, a core network 11, an access network 12, and multiple clients 15-1 to 15-4.

The origin server 10 is a computer comprising a processor, a memory, a storage device, and an I/O unit. The storage device stores original data of the content that is requested by the clients. The origin server 10 exists in a network outside of the clients 15-1 or the like, and the origin server and the clients are connected via the core network 11.

The access network 12 is a network near to the client, and to which the clients 15-1 to 15-4 are connected. The core network 11 is a network connected to the upstream of the access network 12.

The access network 12 includes routers 13-1 to 13-2, cache servers 14-1 to 14-2, a cache cooperation router 16, and cache control servers 17-1 to 17-2.

The routers 13-1 to 13-2 are data forwarding devices comprising an input/output interface and a packet processing unit.

The cache servers 14-1 to 14-2 are computers comprising a processor, a memory, a storage device, and an I/O unit. They store content supplied from the origin server 10 in the storage device, to constitute a distributed cache system.

The cache cooperation router 16 is a data forwarding device comprising an input/output interface and a packet processing unit, and determines whether the content requested by a client is stored or not in the cache system.

The cache control servers 17-1 to 17-2 are computers comprising a processor, a memory, a storage device, and an I/O unit, and manages the content information stored in the cache servers in the distributed cache system. Each of the cache control server manages a content space independently. In FIG. 1, two cache control servers are illustrated, however, three or more servers can also be provided.

The clients 15-1 to 15-4 are computers comprising a processor, a memory, a storage device, and an I/O unit. A user requests content using the client 15-1 or the like.

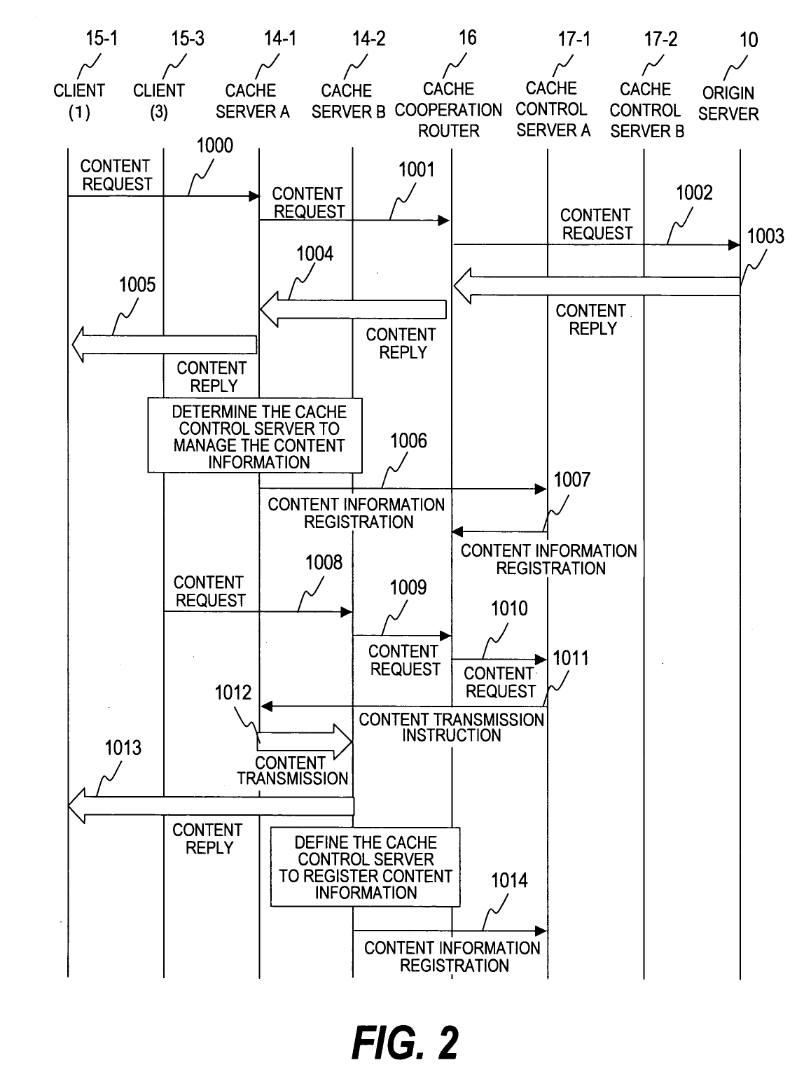

Next, operation of the distributed cache system of the first embodiment will be described with reference to FIG. 2.

Particularly, the operation of the cache system at the time when a client (1) 15-1 makes a request for content identified by URL (Uniform Resource Locater) http//www.ab.ne.jp/content.html, then a client (3) 15-3 makes same request, will be described. The content identified by the URL is not stored in any cache server in the cache system at the time when the client (1) 15-1 makes a request.

First, the client (1)15-1 sends a content request for the URL to a cache server A 14-1 (1000).

The cache server A14-1 receives the content request for the URL from the client (1) 15-1, and searches the content stored in the cache server A14-1. However, since the cache server A14-1 does not store the content of the URL, it sends the content request to the origin server 10 (1001).

The cache cooperation router 16 which relays the content request from the cache server A14-1 determines whether there is the cache server storing the requested content in cache or not. In this case, as no cache server stores the content in cache, the request is determined as “miss hit”. The cash cooperation router 16 sends the content request to the origin server 10 (1002).

The origin server 10 sends the content to the client (1) 15-1 via a path which is reverse to that of the content request, that is, from the origin server 10 to the client (1) 15-1 via the cache cooperation router 16 and the cache server A14-1 (1003 to 1005).

The cache server A14-1 receives the content at sequence 1004, selects a cache control server that is to manage the content information, and sends the content information to the selected cache control server (1006). In FIG. 2, the cache control server A 17-1 is selected, and the content information is sent from the cache server A14-1 to the cache control server A17-1.

The cache control server A17-1 receives the content information, updates the content information management table of the cache control server A17-1, and registers content information in the cache cooperation router 16 (1007).

Next, operation sequence at the time when a client (3)15-3 makes a content request for http://www.ab.ne.jp/content.html will be described.

First, the client (3)15-3 makes a content request for the URL to nearby a cache server B14-2 (1008).

The cache server B14-2 receives the content request for the URL from the client (1) 15-3, searches the content stored in the cache server B14-2. However, since the cache server B14-2 does not store the content of the URL, it sends the content request to the origin server 10 (1009).

The cache cooperation router 16 which relays the content request from the cache server B14-2 determines whether there is the cache server storing the requested content in cache or not. When a hit is found between the requested content and a cache hit determination table, it can be determined that one of the cache servers manages the content information. The cache control server A17-1 that manages the content information is identified, and the content request is forwarded to the cache control server A17-1 (1010).

The cache control server A17-1 receives the content request, identifies the cache server A14-1 which stores the content, and instructs the cache server A14-1 to forward the content to the cache server B14-2 (1011).

The cache server A 14-1 receives the content forward instruction, and sends the content to the cache server B14-2 (1012).

The cache server B14-2 receives the content from the cache server A14-1, and sends the content to the client (3) 15-3 which requested from the content (1013). Then the cache control server which is to manage the content information is selected, and the cache content information is registered in the selected cache control server A 17-1.

The cache control server A17-1 receives the cache content information, and adds the address of the cache server B14-2 in the cache server address field in the entry of the content information management table which manages the content information. As the notification that the content is stored in the cache system has already been sent to the cache cooperation router 16, a process to register the content information in the cache cooperation router 16 will not be carried out.

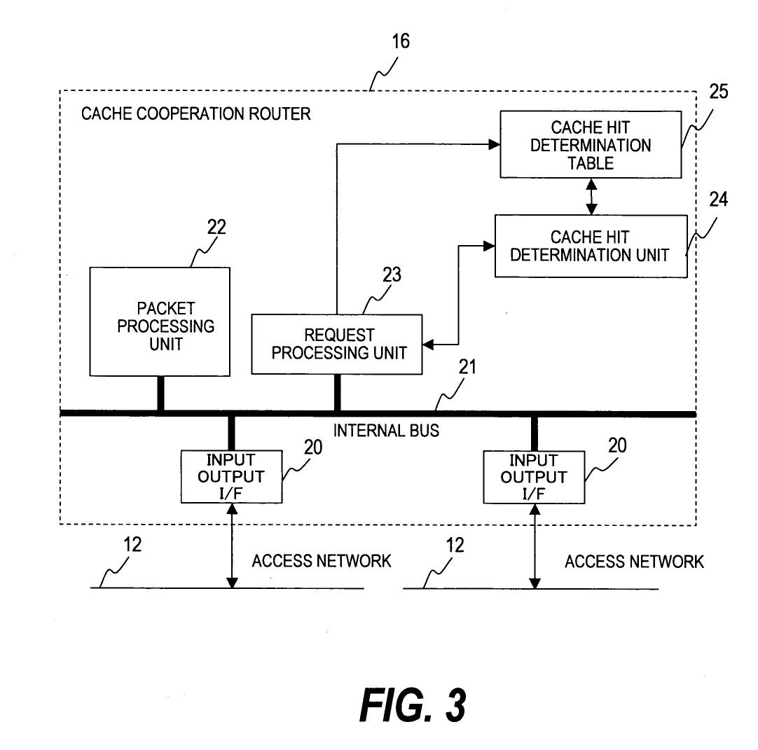

FIG. 3 shows an exemplary structure of the cache cooperation router 16 according to the first embodiment.

The cache cooperation router 16 includes an input/output interface 20, a packet processing unit 22, a request processing unit 23, a cache hit determination unit 24, and a cache hit determination table 25.

The input/output interface 20 is an interface which is connected to the access network 12 and sends/receives packets with the cache servers 14-1 or the like and the cache control servers 17-1 or the like in the distributed cache system. The packet processing unit 22 processes the packet received at the input/output interface 20, and determines where to forward the packet.

The request processing unit 23 processes the request, when the received data is a content request. The cache hit determination unit 24 determines whether the requested content is stored or not in the cache system.

The packet processing unit 22, the request processing unit 23, and the cache hit determination unit 24 are constituted by processes carried out by the processor provided in the cache cooperation router 16. Alternatively, they can be constituted by hardware logics.

The cache hit determination table 25 is stored in a memory unit such as a memory, and includes content information stored in the cache system. The table is referred when the cache hit determination unit 24 determines whether the requested content is stored or not in the cache system.

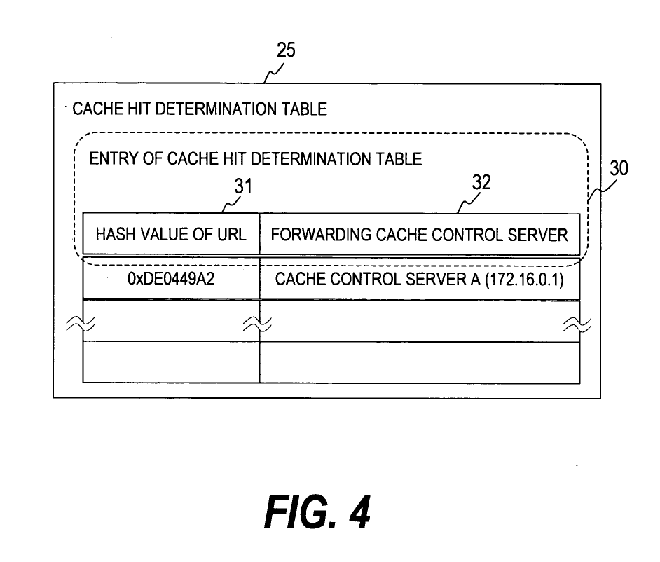

FIG. 4 shows an exemplary structure of the cache hit determination table 25 according to first embodiment of the invention.

The cache hit determination table 25 includes one or more entry of cache hit determination table 30. Each of the entry of cache hit determination table 30 includes a hash value of URL field 31 and a forwarding cache control server address field 32 as fields to store actual data.

The hash value of URL field 31 is a field which stores a hash value converted from URL of the requested content.

The forwarding cache control server address field 32 is a field which stores the address of the cache control server which manages the content information identified by the value stored in the hash value of URL field 31. In this embodiment, it is IP address of the cache control server 17-1.

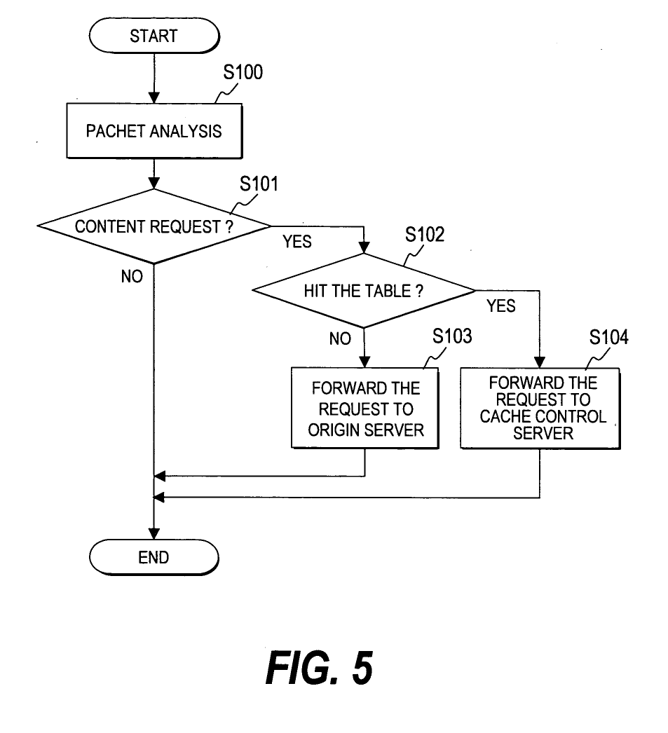

FIG. 5 is a flow chart of exemplary processes at the cache cooperation router 16 when a content request is received according to the first embodiment.

The cache cooperation router 16 receives a packet at the input/output interface 20, and forwards the received packet to the packet processing unit 22.

The packet processing unit 22 analyzes the received packet (S100) to determine whether the received packet is a content request or not (S101). The determination is made based on the destination port address of the packet.

When it is determined that the packet is not a content request, the input/output interface 20 for output is determined based on the destination address in the packet, and the packet is forwarded to the determined input/output interface 20. When it is determined that the packet is a content request, the packet is forwarded to the request processing unit 23.

The request processing unit 23 receives a packet from the packet processing unit 22, and extracts the hash value of URL of the requested content from the packet. The hash value of URL of content is included in the packet and sent from the cache server 14-1 or the like. Then, the cache hit determination unit 24 searches the cache hit determination table 25 by using the extracted hash value as a key, to determine whether the request content is stored or not in the cache system (S102).

When no hit is found in the cache hit determination table 25, the request processing unit 23 forwards the content request to the origin server 10 (S103). When a hit is found in the cache hit determination table 25, it is determined that the content is stored in the access network 12, and address of the cache control server 17 which manages the information on the requested content is acquired from the forwarding cache control server address field 32 of the entry where a hit is found in the cache hit determination table 25. Then the requested is forwarded to the cache control server 17-1 (S104).

The cache cooperation router 16 receives content information newly registered in the cache system from the cache control servers 17-1 or the like. Particularly, the cache cooperation router 16 receives the hash value of URL of the content and the address of the cache control server that sent it. When the cache cooperation router 16 receives content information newly registered, it updates the cache hit determination table 25.

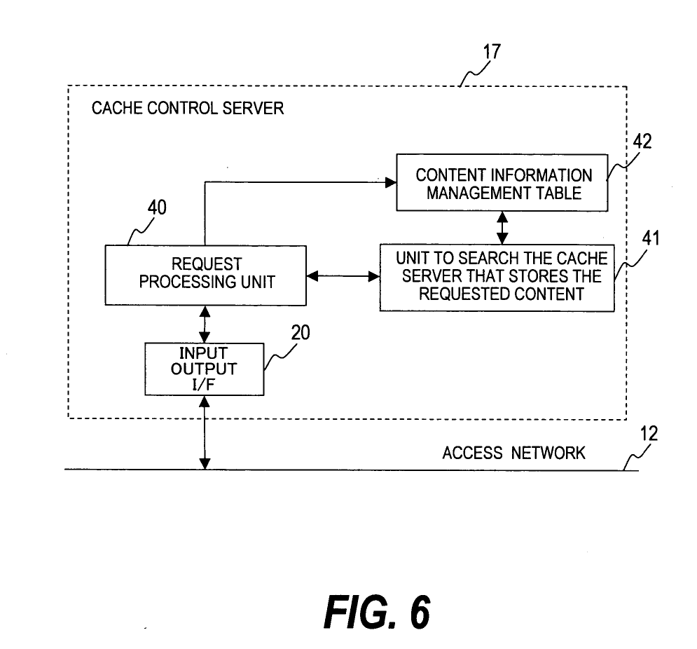

FIG. 6 shows an exemplary structure of the cache control server 17 according to the first embodiment.

First embodiment includes multiple cache control servers having same structure, thus they are collectively referred and described as the cache control server 17.

The cache control server 17 includes an input/output interface 20, a request processing unit 40, a unit to search the cache server that stores the requested content 41, and a content information management table 42.

The input/output interface 20 is an interface which is connected to the access network 12, and sends/receives packets with the cache cooperation router 16.

The request processing unit 40 processes the content request forwarded from the cache cooperation router 16, or cache information on content received from the cache server 14. The unit to search the cache server that stores the requested content 41 searches a cache server which stores the requested content according to the forwarded content request. The request processing unit 40 and the unit to search the cache server that stores the requested content 41 are constituted by processes carried out by a processor in the cache control server 17.

The content information management table 42 is stored in a storage device such as a memory or HDD (hard disk drive), and stores the information of content stored in the access network.

The distributed cache system according to the first embodiment compares the number of content requests from the clients 15-1 or the like, and the capacity of one of the cache control server 17-1 or the like. When the number of requests from the clients exceeds the capacity of one of the cache control server, the cache control servers deployed in the cache system can be increased depending on the number of content requests from the clients.

When a cache control server is newly added to the distributed cache system of the invention, the new cache control server notifies its address to existing cache control servers 17-1 or the like and existing the cache servers 14-1 or the like.

The cache control servers 17-1 or the like receives address information from the new cache control server, and recalculates the name space of content to be managed by the cache control servers. Based on this calculation, content information is exchanged between the cache control servers if needed.

Subsequent to the exchange of content information, the content information which is managed by the new cache control server is notified to the cache cooperation router 16. The cache cooperation router 16 receives a notification indicating change in the cache control server, and updates the forwarding cache control server address field 32 in the cache hit determination table 25.

Methods to the divide address space to be managed by each of the cache control server includes a method in which a hash value converted from URL of the content is divided by the number of the cache control servers present in the cache system, and using the remainder to define the cache control server which is to manage the content.

In the distributed cache system according to the first embodiment, when the number of requests from the clients 14-1 or the like decreases and can be processed by reduced the number of the cache control servers 17-1 or the like, the cache control servers deployed in the cache system can be decreased.

When reducing the number of the cache control servers, the cache control server which stops its operation notifies its address to other cache control servers and the cache server 16. The cache control server which receives the notification calculates again the address space to be managed by the cache control servers. Content information may be exchanged between remaining the cache control servers if needed.

Subsequent to the exchange of content information, the content information to be managed by the new cache control server is notified to the cache cooperation router 16. The cache cooperation router 16 receives the notification, and updates the forwarding cache control server address field 32 of the cache hit determination table 25.

Subsequent to the exchange of content information between the cache control servers, the cache control server to stop its operation stops the operation.

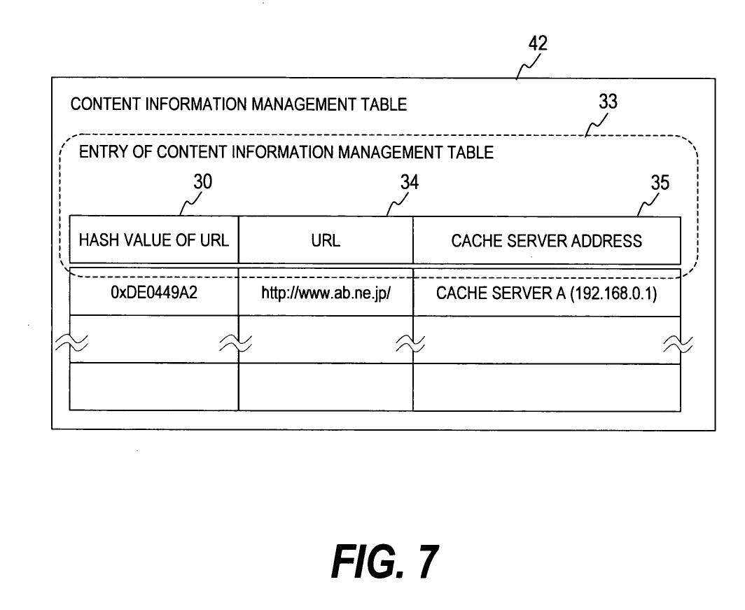

FIG. 7 shows an exemplary structure of the content information management table 42 according to the first embodiment of the invention.

The content information management table 42 includes one or more entry of content information management table 33. Each of the entry of content information management table 33 includes a hash value of URL field 31, an URL field 34, and a cache server address field 35 as fields to store the cache server address that stores the actual data.

The hash value of URL field 31 is a field which stores the value same as that stored in the hash value of URL field 31 included in the cache hit determination table 25 (FIG. 4).

The URL field 34 is a field which stores the address of the original data of content. Particularly, the URL field 34 stores URL of the content.

The cache server address field 35 is a field which stores the address of the cache server 14 storing the content identified by the character string stored in the URL field 34.

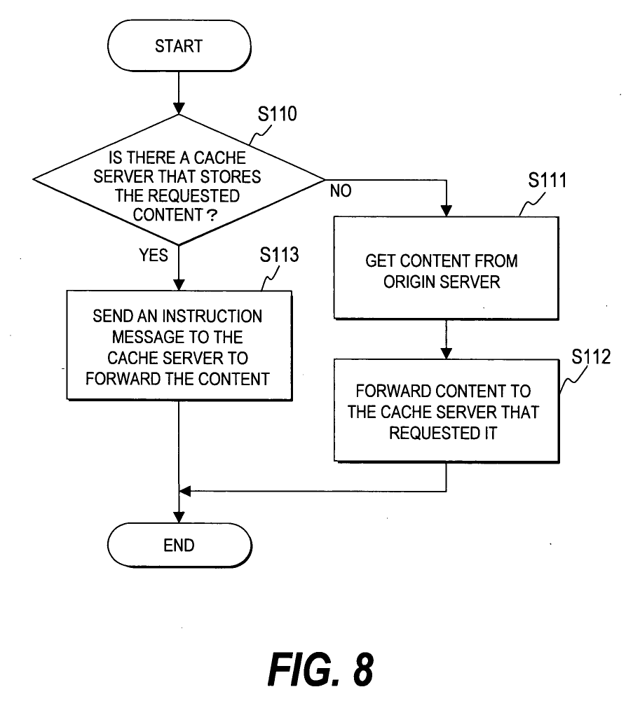

FIG. 8 shows a flow chart of processes when the cache control server 17 of the first embodiment receives a content request packet from the cache cooperation router 16.

When the cache control server 17 receives a content request from the cache cooperation router 16 via the input/output interface 20, the request processing unit 40 inquires the address of the cache server storing the content to the unit to search the cache server that stores the requested content 41, using a hash value converted from URL of the content included in the request packet as a key.

The unit to search the cache server that stores the requested content 41 receives an inquiry for the address of the cache server, and refers to the content information management table 42 to search a cache server which stores the content (S110). The unit to search the cache server that stores the requested content 41 returns the search result to the request processing unit 40.

When there is no cache server which stores the content, the content is acquired from the origin server 10 which stores the original data of the content (S111) and sent to the cache server that requested it (S112).

When there is a cache server which stores the content, the request processing unit 40 instructs the cache server storing the content to forward the content to the cache server that requested it (S113).

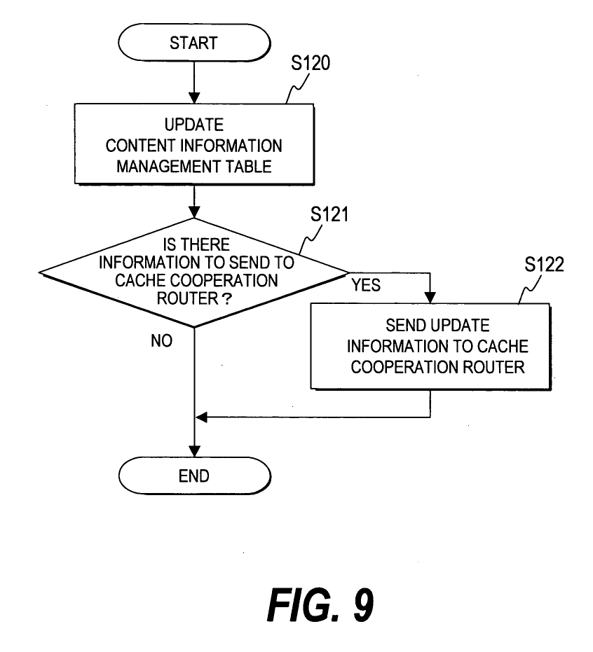

FIG. 9 shows a flow chart of processes when the cache control server 17 receives a notification packet sent by the cache server 14-1 when the cache server 14-1 stores a new content according to the first embodiment.

When the cache control server 17 receives cache information indicating that new content is stored from the cache server 14-1 via the input/output interface 20, the request processing unit 40 updates the information in the content information management table 42 (S120). When URL of the content is present in the URL field 34 of the entry of content information management table 33 of the content information management table 42, the address of the cache server 14-1 which sent the cache information of content is added in the cache server address field 35 in the entry of content information management table 33.

When URL of the content is not present in the URL field 34 of the entry of content information management table 33 of the content information management table 42, the new entry of content information management table 33 is created, and URL of the content included in content information is stored in the URL field 34 of the newly created entry of content information management table 33. A hash value converted from URL of the content is stored in the hash value of URL field 31. The address of the cache server which sent content information is stored in the cache server address field 35.

The request processing unit 40 determines whether notification to the cache cooperation router 16 is necessary or not (S121). When the entry of content information management table 33 is newly created, it is determined that notification to the cache cooperation router 16 is necessary, and the newly cached content information is notified to the cache cooperation router 16 (S122).

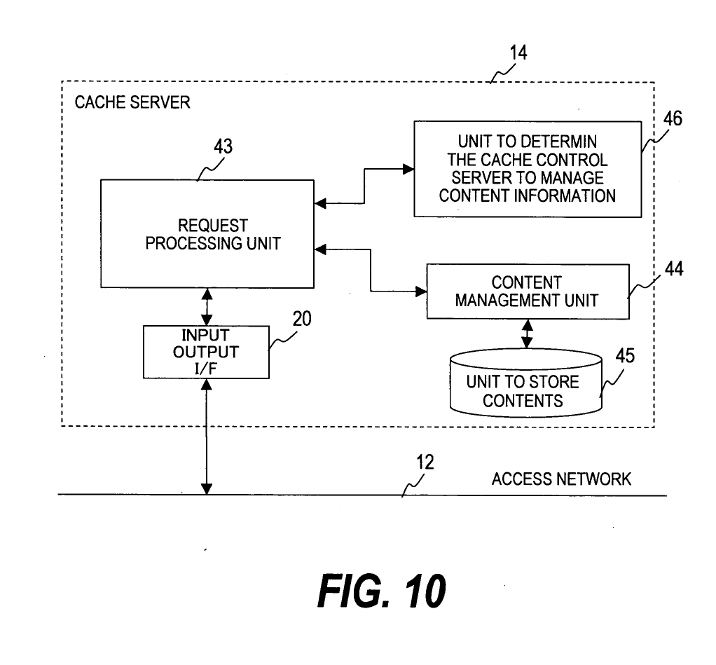

FIG. 10 shows an exemplary structure of the cache server 14 according to the first embodiment.

The distributed cache system according to the first embodiment includes multiple cache servers having same structure, thus they are collectively referred and described as the cache server 14.

The cache server 14 includes an input/output interface 20, a request processing unit 43, a content management unit 44, a unit to store content 45, and a unit to determine the cache control server to manage content information 46.

The input/output interface 20 is an interface connected to the access network 12 and sends/receives packets with the cache cooperation router 16 and the cache control server 17.

The request processing unit 43 processes content requests received from the clients. The content management unit 44 manages content information stored in the cache server 14. The unit to determine the cache control server for managing content information 46 determines the cache control server which cache control server is appropriate to manage the content information stored in the cache server 14.

The request processing unit 43, the content management unit 44, and the unit to determine the cache control server to manage content information 46 are constituted by processes of a processor in the cache server 14.

The unit to store content 45 includes a storage device such as a memory or HDD (hard disk drive) to store content.

The cache server 14 receives a content request from the clients 15-1 or the like, and if the requested content is not stored, the cache server 14 sends the content request to the origin server 10. At this time, the cache server 14 adds a hash value converted from URL of the content to the content request, and sends the content request together with the hash value.

When a cache control server is newly added, the cache server 14 receives and stores the address of the new cache control server from newly added cache control server. The cache server 14 changes the key for determining the content space managed by each of the cache control server, when a new the cache server is added. The key for determining the content space managed by each of the cache control server can be determined by the cache server 14 based on the number of the cache control servers present in the cache system, or can be received from the newly added cache control server.

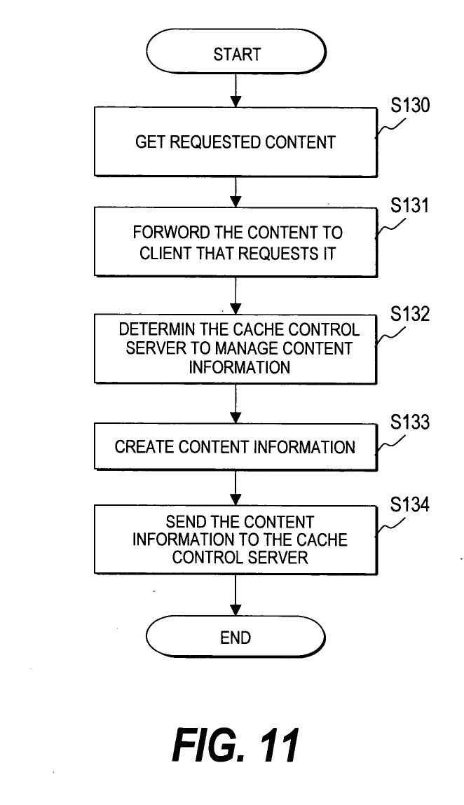

FIG. 11 shows a flow chart of processes when the cache server 14 receives content according to the first embodiment.

The cache server 14 receives the requested content from the origin server 10 or other cache servers in the distributed cache system (S130).

When the cache server 14 receives the requested content, the request processing unit 43 sends the received content to the client that requested it (S131). The request processing unit 43 instructs the content management unit 44 to store the received content.

The content management unit 44 receives an instruction to store the received content from the request processing unit 43, and stores the received content in the unit to store content 45.

The request processing unit 43 sends URL of the content to the unit to determine the cache server to manage content information 46, in order to determine the cache control server to manage the received information.

The unit to determine the cache control server to manage content information 46 receives URL of the content from the request processing unit 43, and with use of the key for determining the content space, selects the cache control server which is to manage the content information. Then, the address of the selected cache control server is sent to the request processing unit 43 (S132).

The request processing unit 43 receives address of the cache control server that is to manage the content information, and generates an outgoing message including location information of content (S133). For the location information of content, a hash value converted from URL of the received content, and address of the cache server 14 can be used. And the outgoing message including the location information of content is sent to the selected cache control server (S134).

In the first embodiment, when the content space managed by each of the cache control server is changed due to addition of the new cache control server, the cache control server which manages the content information can be updated using a request from the client as a trigger. In this case, processes different from above description will be carried out when the cache control server receives a content request.

In a modified first embodiment, even if the content space managed by each of the cache control server is updated at the time the new cache control server is added, content information is not exchanged between the cache control servers. The cache control server updates the content information at the time when a hit is found in the cache cooperation router for a content request received from the cache server, and the content request from the cache server is forwarded to the cache control server. At this time, the cache control server to which the content request is to be forwarded is the cache control server which managed the content information of the relevant content before addition of the cache control server.

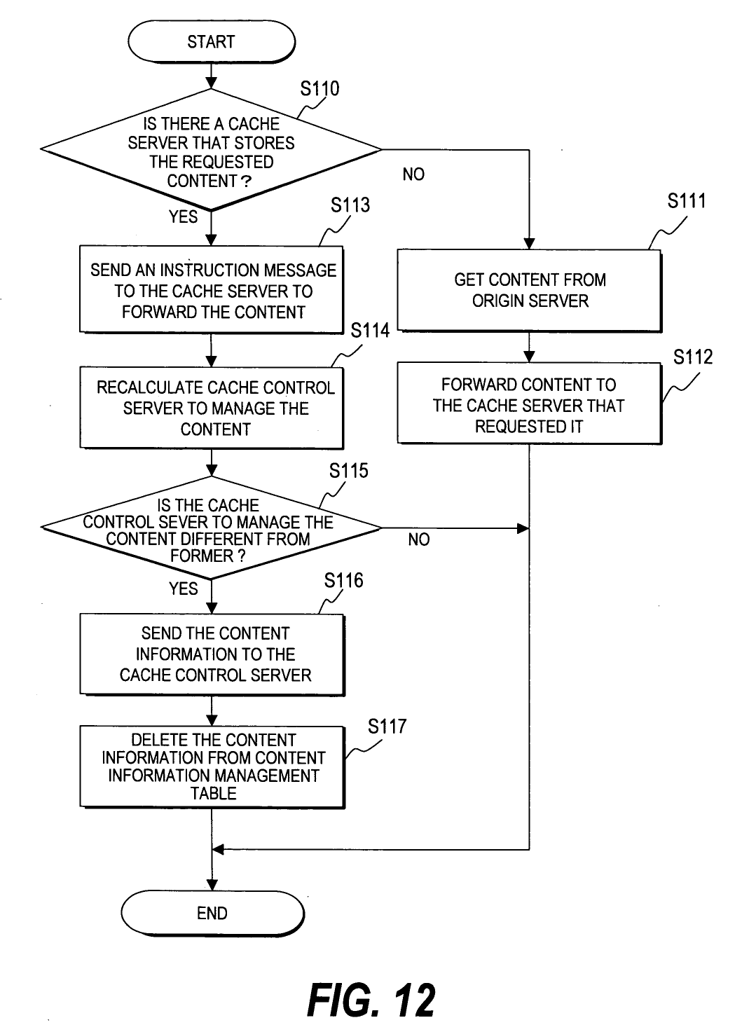

FIG. 12 shows processes in a modified first embodiment, wherein when the content space managed by the cache control server is changed, the cache control server 17 receives a content request and updates the cache control server to manage the content information using a content request from the client 15-1 or the like as a trigger.

The process in this modification is different from that shown in FIG. 8 in that the content information is updated after instructing the cache server which stores content to forward the content. In FIGS. 12 and 8, identical processes have identical numbers, and detailed description will be omitted.

The cache control server 17 instructs the cache server 14 storing the content to forward the content (S113), and re-calculates the cache control server that is to manage the content information (S114).

Then, it is determined whether the cache control server that is to manage the content information is different or not from the cache control server which managed the content information before addition of the new cache control server (S115).

When the cache control server to manage the content is different from former one, the cache control server which managed the content information before addition of the new cache control server sends the content information to the cache control server that is to store the content information (S116), and deletes the content information from the content information management table (S117).

When the same cache control server is to manage the content, no process is performed.

As described above, in a modified first embodiment, exchange of content information is not necessary at the time when the cache control server is newly added, thus, the number of processes at the cache control server can be reduced. Furthermore, it is not necessary to exchange the content information which is requested only once between the cache control servers, thus, the traffic between the cache control servers can be reduced.

As described above, the first embodiment of the invention can provide a distributed cache system where the cache control servers can be added when requests from the clients increase in a network to which many the clients are connected. Therefore, a distributed cache system optimal for the number of the clients can be provided, and the cost necessary to construct and extend a distributed cache system can be reduced.

### Second Embodiment

Next, a distributed cache system according to the second embodiment of the invention will be described.

The distributed cache system according to the second embodiment is characterized in that the traffic is processed by multiple cache cooperation routers. This system is effective when the requests from the clients increases and cannot be processed by one of the cache cooperation router.

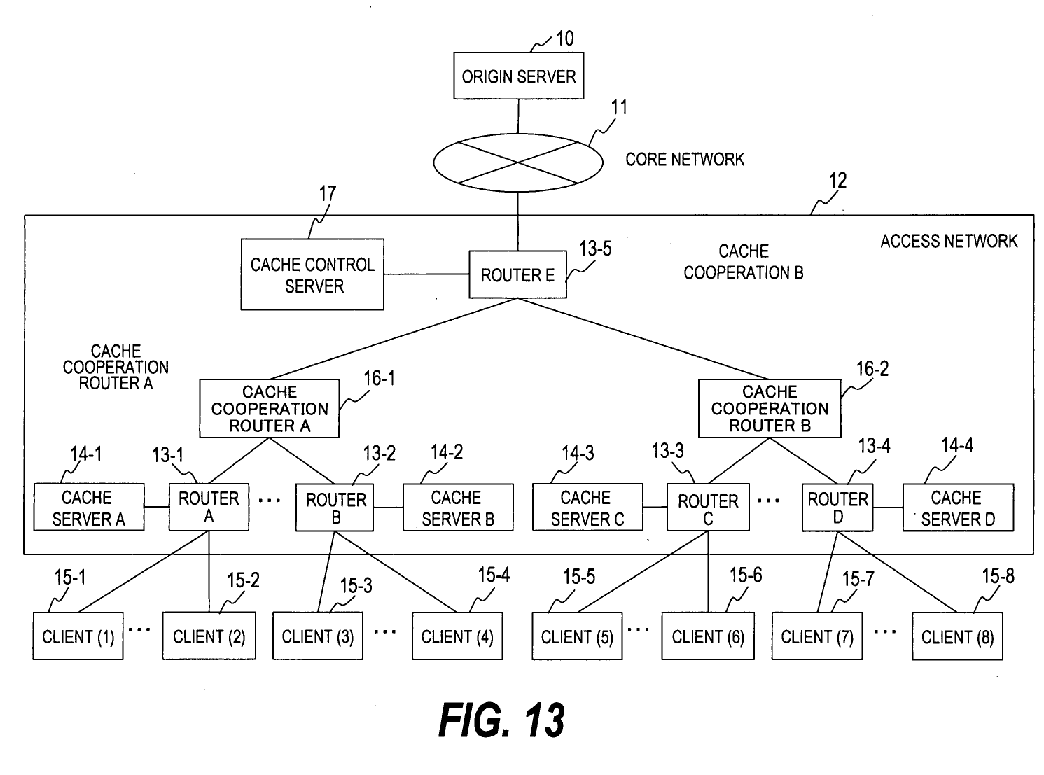

FIG. 13 is a block diagram which shows an exemplary structure of a distributed cache system according to the second embodiment.

The distributed cache system of the second embodiment is different from that of the first embodiment as described (FIG. 1) in that it includes multiple the cache cooperation routers and one of the cache control server. In FIG. 13, two cache cooperation routers are provided, however, three or more cache cooperation routers can be provided. The components identical to those in the first embodiment have same reference numerals, and detailed description will be omitted.

In the distributed cache system of the second embodiment, when a cache cooperation router is newly added, the new cache cooperation router notifies its address to the cache control server 17. The cache control server 17 receives the address notification from the new cache cooperation router, and sends all content information stored in a content management information table managed by itself to the new cache cooperation router.

By the above process, the new cache cooperation router can store the information same as that stored by the existing cache cooperation routers, and can perform the processes same as those carried out by the existing cache cooperation routers.

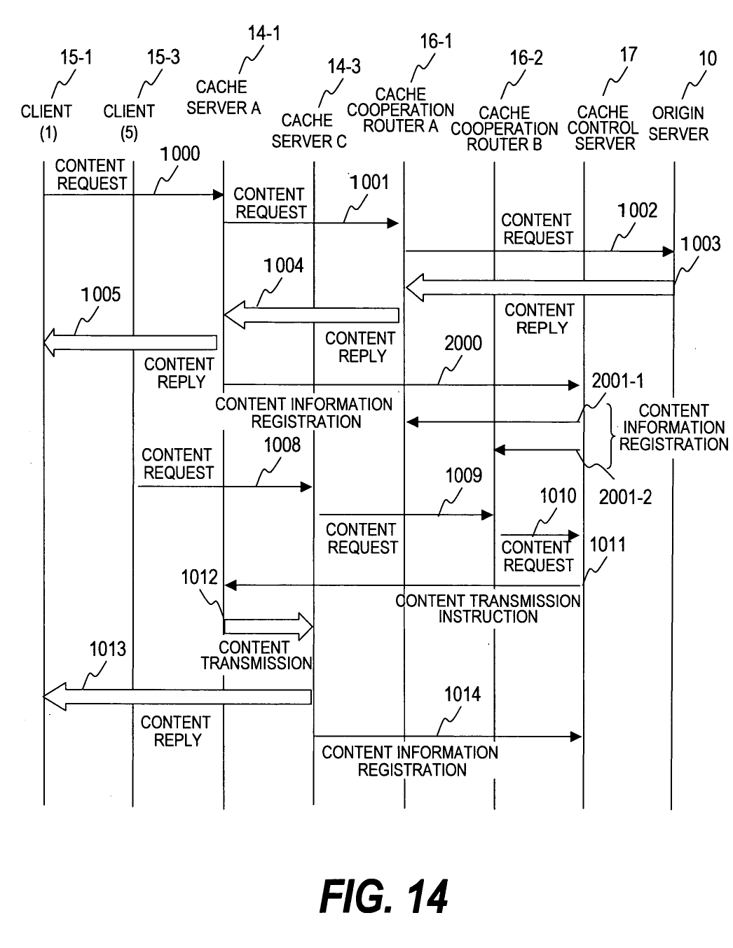

Next, the operation of distributed cache system according to the second embodiment will be described with reference to FIG. 14.

Particularly, the operation carried out by the cache system when the client (1) 15-1 shown in FIG. 13 makes a request for content identified by URL http://www.ab.ne.jp/content.html, then the client (3) 15-3 makes same request will be described. The content of the URL is stored in no cache server in the cache system at the time when the client (1) 15-1 makes a request.

The second embodiment is different from the first embodiment as described (FIG. 2) in that when the cache control server 17 receives content information from the cache server A14-1, the content information is stored in all of the cache cooperation routers in the cache system. The processes identical to those in the first embodiment (FIG. 2) have identical reference numerals, and detailed description will be omitted.

The cache server A14-1 receives the content at sequence 1004, and sends the content information to the cache control server 17 (2000).

The cache control server 17 receives the content information, updates the content information management table of the cache control server 17 to register the content information in all of the cache cooperation routers (in this embodiment, the cache cooperation routers A16-1 and B16-2) in the cache system (2001-1, 2001-2).

In contrast to the first embodiment, the cache server does not divide the content space to be managed by multiple cache control servers. It is not necessary to specify the cache control server to manage the content information.

As described, the second embodiment of the invention can provide a distributed cache system to which the cache control servers can be added when requests from the clients increase in the network having many the clients. Therefore, a distributed cache system optimal for the traffic volume can be provided and cost necessary to construct and extend the distributed cache system can be reduced.

### Third Embodiment

Next, a distributed cache system according to a third embodiment of the invention will be described.

In the third embodiment, a cache system which enables transmission/receipt of content between domains in the access network having multiple domains will be described.

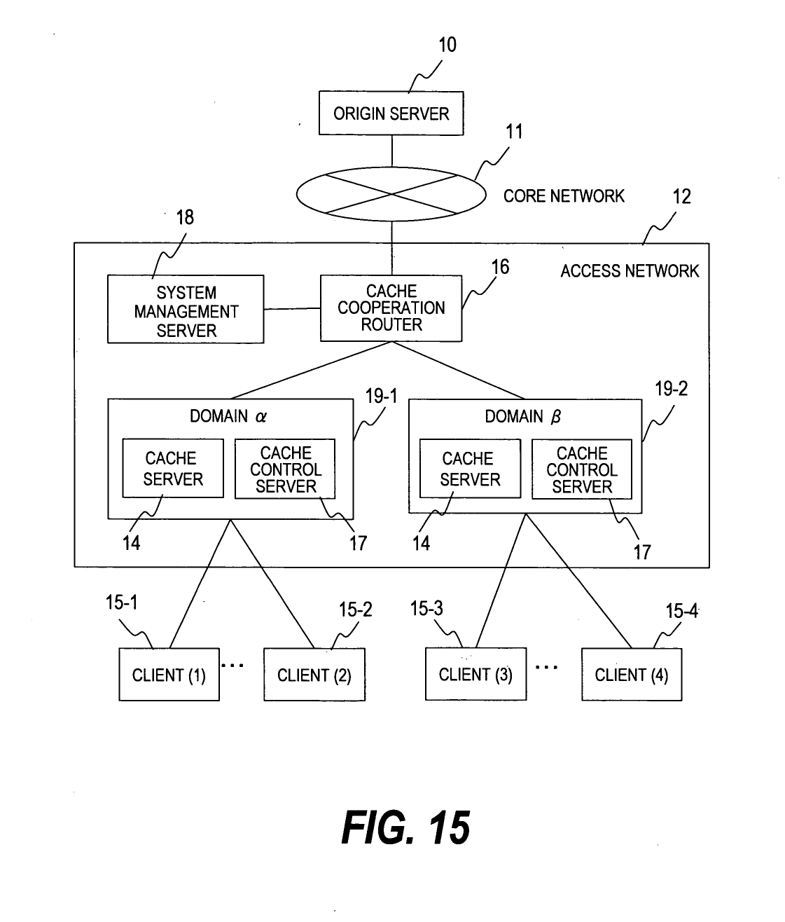

FIG. 15 is a block diagram which shows an exemplary structure of a distributed cache system of the third embodiment.

The components identical to those in the first embodiment have same reference numerals, and detailed description will be omitted.

The domains 19-1 and 19-2 respectively has a cache system comprising the cache server 14 which stores the content, and the cache control server 17 which controls transmission/receipt of the content information. The cache control server included in the domain sends updated content information to system management server at the time when the information in the content information management table managed by the cache control server itself is updated. In FIG. 15, the access network has two domains, however, it can have three or more domains. The domain is a segment divided by a cooperation or region.

Each of the domain is connected to the cache cooperation router 16. A system management server 18 which controls cooperation of the cache in the whole access network is connected to the cache cooperation router 16.

The structure of the cache cooperation router 16 of the third embodiment is substantially same as that of the cache cooperation router of the first embodiment (FIG. 3), except the structure of the cache hit determination table 25.

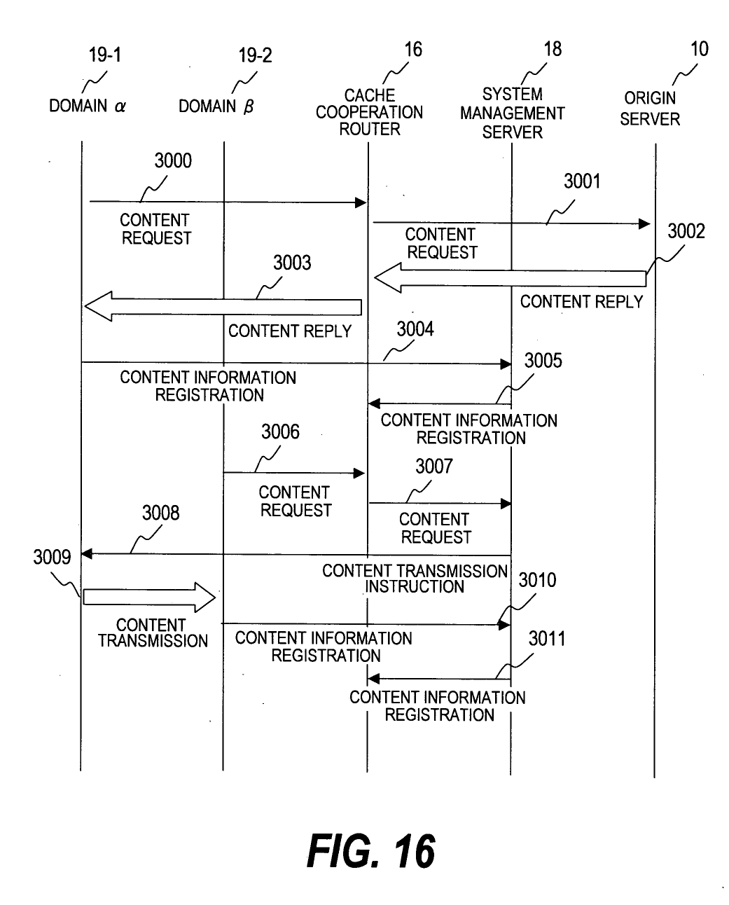

Next, with reference to FIG. 16, the operation of the distributed cache system will be described when content of URL http://www.ab.ne.jp/content.html is requested from the domain α 19-1 shown in FIG. 15, then the domain β 19-2 makes same request. The content identified by the URL is not stored in the cache system at the time when a request for it is made from domain α.

A request for content of the URL is sent from the domain α (3000).

The cache cooperation router 16 which relays the content request from the domain α searches the cache hit determination table 25 to determine whether there is any domain which stores the requested content. Since the content is not stored in any domain, it is determined to be “miss hit”. The cache cooperation router 16 sends the content request to the origin server 10 (3001).

The content is returned to the domain α via a path that is a reverse to the content request path, that is, from the origin server 10 to the domain a via the cache cooperation router 16 (3002, 3003).

The cache control server of the domain α receives the content, and sends information indicating that it stores the content to the system management server 18 (3004). The system management server 18 registers the received content information in a content information management table 52, and notifies that it registered the content information to the cache cooperation router 16 (3005).

The cache cooperation router 16 receives the information, and registers it in the cache hit determination table.

Next, a sequence of process when the client included in the domain β makes a request for content identified by URL http://www.ab.ne.jp/content.html subsequent to the above process will be described.

First, the domain β sends a content request for the URL (3006).

The cache cooperation router 16 which relays the content request from the domain β searches the cache hit determination table 25 to determine whether there is any domain that stores the requested content. It is determined that the content is stored in the domain α. The cache cooperation router 16 forwards the content request, and information indicating that a hit is found between the content and the cache hit determination table of the domain α, to the system management server 18 (3007).

The system management server 18 receives the content request, searches the content information management table 52 of the domain α, and instructs the cache control server of the domain α to forward the content to the domain β (3008).

The cache control server of the domain α receives the content forward instruction, and sends the content to the domain β (3009).

The cache control server of the domain β receives the content, and sends information indicating that it stores the content to the system management server 18 (3010).

The system management server registers the received content information in the content information management table 52, and notifies that it registers the content information to the cache cooperation router 16 (3011).

The cache cooperation router 16 receives a notification indicating the registration of content information, and registers the information in the cache hit determination table 25.

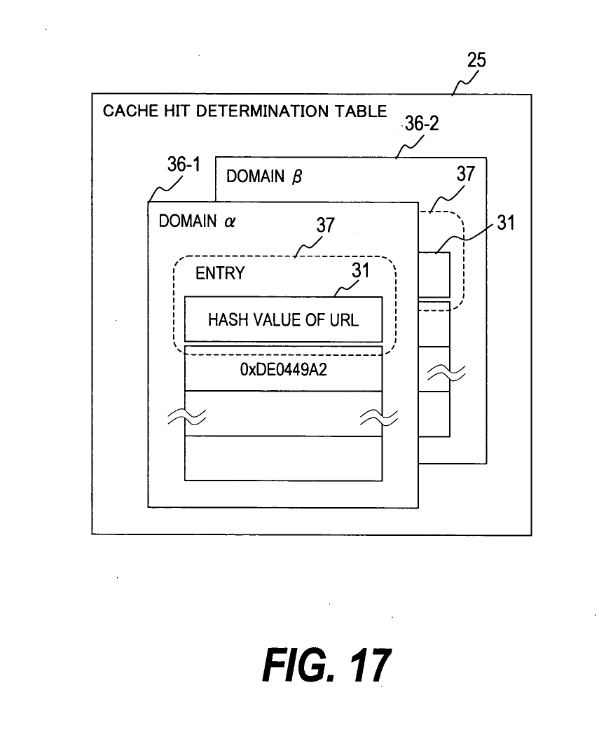

FIG. 17 shows an exemplary structure of the cache hit determination table 25 of the cache cooperation router 16 according to the third embodiment.

The cache hit determination table 25 of the cache cooperation router 16 of the third embodiment includes domain cache hit determination tables 36 for the each domain in the access network. Each of the domain cache hit determination table 36 includes one or more entry of the domain cache hit determination table 37. Each of the entry of the domain cache hit determination table 37 includes URL hash value field 31.

The hash value of URL field 31 of the domain cache hit determination table 36 stores a hash value converted from URL of the content present in the domain.

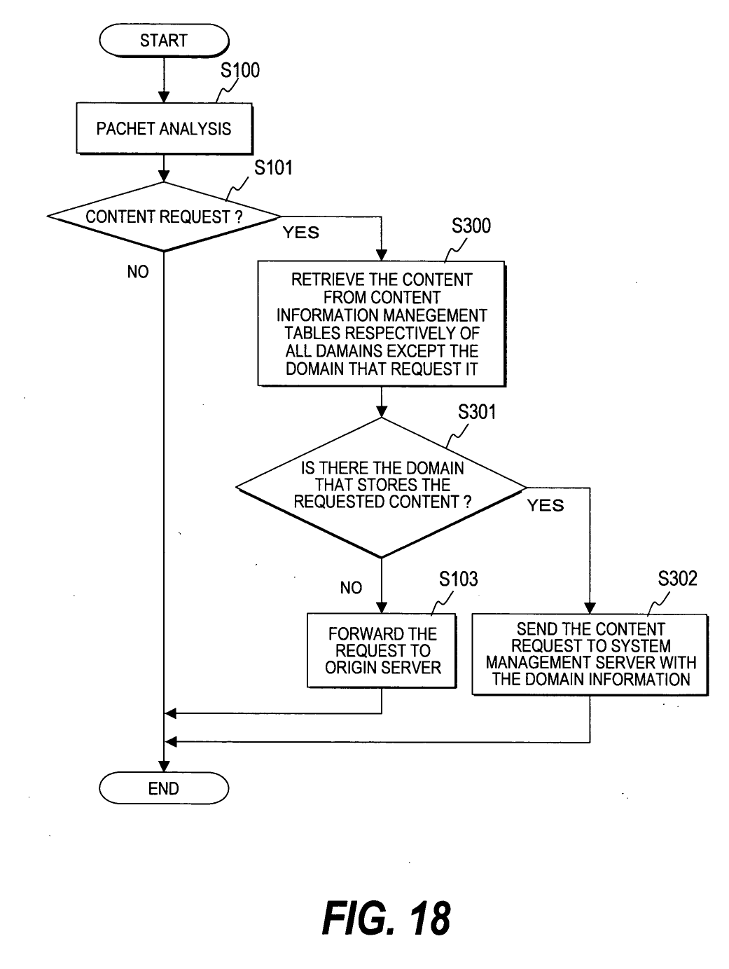

FIG. 18 is a flow chart showing processes at the time when the cache cooperation router 16 of the third embodiment receives a content request from the client included in the domain.

The cache cooperation router 16 of the third embodiment carries out processes necessary for cooperation between the domains, in addition to processes carried out by the cache cooperation router 16 in the first embodiment as above (FIG. 5). In these processes, the method to search the cache hit cooperation table at the time when it receives a content request is different. The processes identical to those in the first embodiment have identical reference numerals, and detailed description will be omitted.

The request processing unit 23 receives a packet from the packet processing unit 22, and extracts from the packet the hash value of the URL of the requested content. The hash value of the URL of the content is included in the content request, and sent from the cache server 14. The cache hit determination unit 24 searches the cache hit determination table 25 using the extracted hash value, and determines whether the requested content is stored or not in the cache system (S300).

At this time, the cache hit determination unit 24 searches in the cache hit determination table 36 of the domains other than that requested it, using the extracted hash value as a key (S301). The search in the cache hit determination tables can be carried out sequentially for the each domain, or in parallel for the cache hit determination tables of the domains to be searched.

When there is not the entry of the requested content in the cache hit determination table of the domains, the request processing unit 23 determines that the content is not stored in the access network 12, and forwards the content request to the origin server 10 (S103). When there is the entry of the requested content in the domain cache hit determination table 36 of one of the domains, the request processing unit 23 sends the content request packet and an identifier of the domain having the cache hit determination table 25 in which the hit is found, to the system management server 18 (S302).

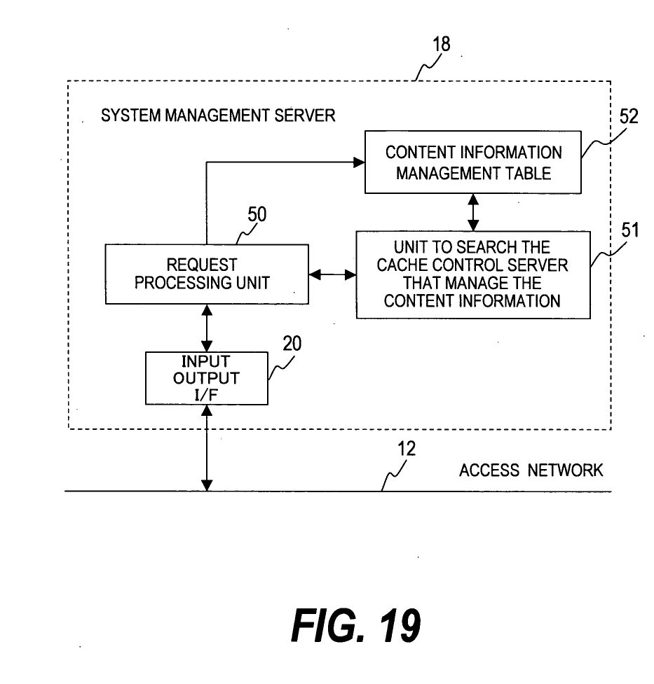

FIG. 19 shows an exemplary structure of the system management server 18 of the third embodiment.

The system management server 18 includes an input/output interface 20, a request processing unit 50, a unit to search the cache control server that manages the content information 51, and the content information management table 52.

The input/output interface 20 is an interface connected to the access network 12 and sends/receives packets with the cache cooperation router 16.

The request processing unit 50 processes a content request forwarded from the cache cooperation router 16, and the information of newly cached content received from the domain 19.

The unit to search the cache control server that manages the content information 51 searches the cache control server which manages the content information.

The request processing unit 50 and the unit to search the cache control server that manages the content information 51 are constituted by processes carried out by the processor in the system management server 18.

The content information management table 52 stores the content information stored in the access network, and is constituted by a storage device such as a memory or HDD (hard disk drive).

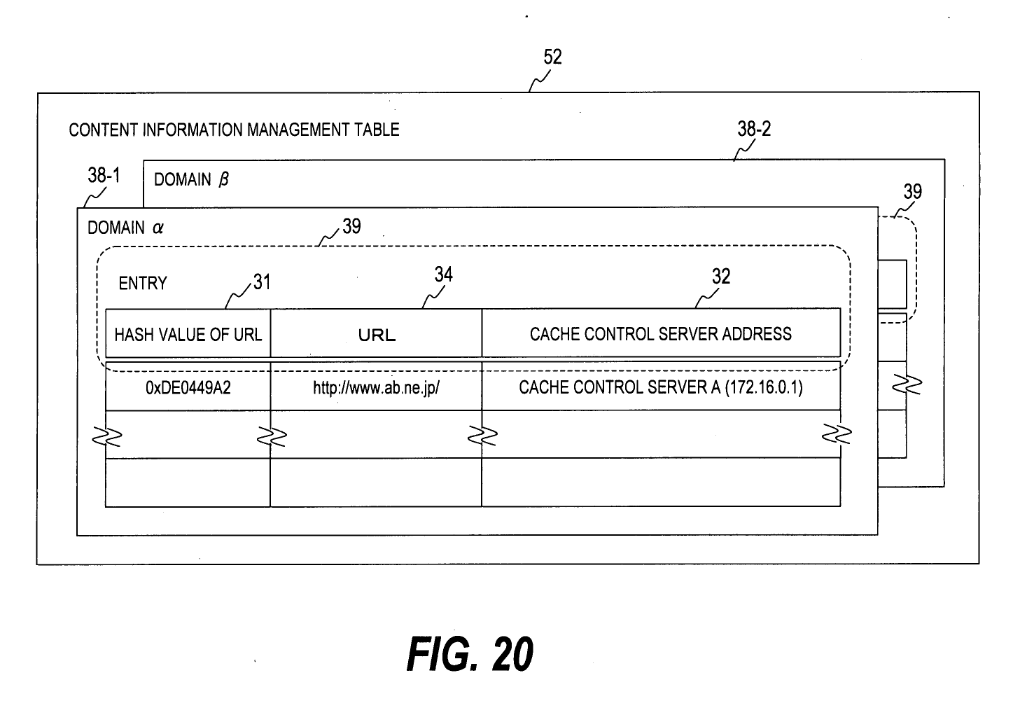

FIG. 20 shows an exemplary structure of the content information management table 52 of the system management server 18 according to the third embodiment.

The content information management table 52 includes the domain content information management tables 38 which stores the content information stored in the each domain. The each domain present in the cache system has one of the domain content information management table 38.

The domain content information management table 38 includes one or more entry of the domain content information management table 39. Each of the entry of the domain content information management table 39 includes a hash value of URL field 31, an URL field 34, and a cache control server address field 32 as the fields for storing actual data.

The hash value of URL field 31 is a field which stores the value same as that stored in the hash value of URL field 31 included in the cache hit determination table 25 (FIG. 4). The URL field 34 is a field which stores the value same as that stored in the hash value of URL field 31 included in the content information management table 42 (FIG. 7). The cache control server address field 32 is a field which stores the value same as that stored in the forwarding cache control server address field 32 included in the cache hit determination table 25 (FIG. 4).

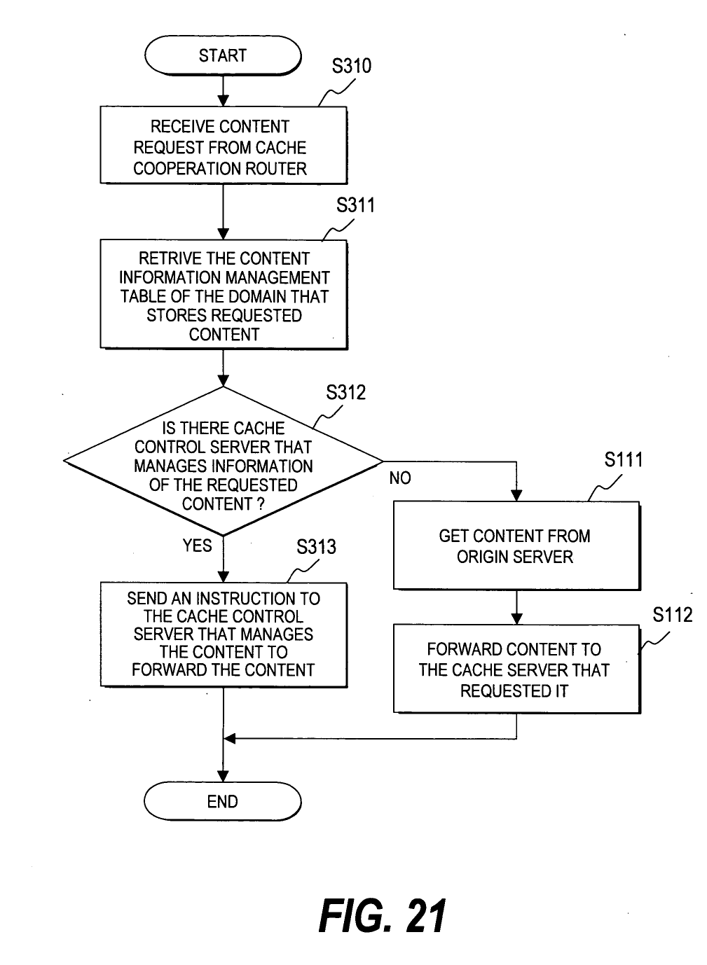

FIG. 21 shows a flow chart showing processes carried out when the system management server 18 receives a content request packet from the cache cooperation router 16 according to the third embodiment.

The system management server 18 receives a content request, and the identifier of the domain having the cache hit determination table 25 of the cache cooperation router 16 in which a hit is found, from the cache cooperation router 16 via the input/output interface 20 (S310).

The request processing unit 50 searches the domain content information management table of the domain in which a hit is found for the content, using the acquired a domain identifier (S311). It is determined whether there is any cache control server that manages the content information (S312).

When there is the cache control server which manages the content information, the request message is sent to the cache server in step S313 (S313) to instruct the cache server which manages the content to forward the content to the server that requested it.

When there is no cache control server that manages the content information, the content is acquired from the origin server 10 which stores the original data of the content (S111), and the acquired content is sent to the cache server that requested it (S112). The steps S111 and S112 are same as those carried out in the cache control server of the first embodiment described in FIG. 8, so that they have reference numbers similar to those in FIG. 8.

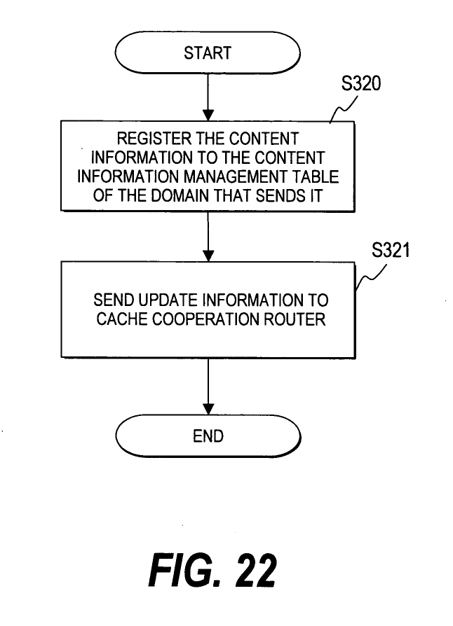

FIG. 22 is a flow chart showing processes carried out when the system management server 18 receives a notification packet indicating that the cache control server newly caches content, from the cache control server in the domain.

The system management server 18 receives content cache information from the cache control server via the input/output interface 20. The request processing unit 50 adds the content information to the domain content information management table which manages the content information of the domain of the cache control server that sent it (S320).

The content information together with the domain identifier is sent to the cache cooperation router (S321).

As explained above, according to the third embodiment of the invention, the cache systems in several domains work in cooperation with each other, to find a hit efficiently in the access network. By reducing requests to the origin server, the load on the origin server can be reduced, thus, the traffic between the core network and the access network can also be reduced. By determining by domain whether the content required by the client is stored in a distributed cache system, search time of content can be reduced. And by replying from the access network to the content requirement from the client, response time can be reduced, as well.

While the present invention has been described in detail and pictorially in the accompanying drawings, the present invention is not limited to such detail but covers various obvious modifications and equivalent arrangements, which fall within the purview of the appended claims.

What is claimed is:

1. A cache system comprising:
multiple cache servers which stores content requested from a client;
multiple cache control servers which manages the content information stored in the cash server; and
a cache cooperation router which determines whether the content requested from the client is stored or not in the cache system,
wherein multiple cache control servers shares and manages the content information stored in the cache system,
wherein the cache cooperation router grasps the content information managed by the each cache control server,
wherein the cache cooperation router identifies the cache control server that manages the requested content information when receiving a content request from the client, and
wherein the cache cooperation router forwards the request from the client to the identified cache control server.

2. The cache system according to claim 1, wherein the cache cooperation router stores a hash value calculated from the identifier of the content stored in the cache system and hit determination information including the relationship with the address of the cache control server that manages the content information, determines, by referring to the hit determination information, whether the content requested from the client is stored or not in the cache system, identifies the cache control server that manages the requested content information, and forwards the content request from the client to the identified cache control server.

3. The cache system according to claim 1, wherein the cache server receives an address notification from a newly added cache control server, identifies the cache control server that manages the content information using the number of the cache control servers included in the cache system when the cache server receives new content, and sends the content information to the identified cache control server.

4. The cache system according to claim 1, wherein the new cache control server notifies its own address to all cache servers and the cache control server included in the cache system when being newly added to the cache system.

5. The cache system according to claim 4, wherein, the cache control server calculates the range of content to be managed when receiving an address notification from the new cache control server, and exchanges the content information between the cache control servers based on the result of the calculated the range of content.

6. The cache control server according to claim 4, wherein the cache control server controls the exchange of content between the cache servers when receiving a content request from the cache cooperation router, calculates the cache control server that manages the content information, and forwards the content information to a cache control server that is to manage the content information in case of which it is determined, based on the calculation, that the content information should be managed by a cache control server other than the server currently managing the content.

7. A cache system comprising:
multiple cache servers which stores content requested from a client;
a cache control server which manages the content information stored in the cache servers; and
at least one cache cooperation router which determines whether the content requested from the client is stored or not in the cache system,
wherein the new cache cooperation router notifies its address to the cache control server when being added to the cache system, and
wherein the cache control server sends the content information managed by itself to the new cache cooperation router when receiving an address notification from the new cache cooperation router.

8. The cache control system according to claim 7, wherein the cache control server sends the content information to all cache cooperation routers included in the cache system when receiving the content information newly stored from the cache server.

9. A cache system comprising:
multiple cache servers which stores content requested from a client;
a cache control server which manages the content information stored in the cache server; and
a cache cooperation router which determines whether the content requested from the client is stored or not in the cache system,
wherein the network in which the cache system is applied is divided into multiple domains,
wherein the cache system further comprises a system management server which controls forwarding of the content between domains,
wherein the cache control server manages the content information for each domain, and
wherein the cache cooperation router determines whether a content requested from a client in the domain is stored or not in one of other domains.

10. The cache system according to claim 9, wherein the cache cooperation router stores hit determination information including a hash value calculated from the identifier of the content stored in the network for each domain, determines, by referring to the hit determination information, whether the content requested from a client is stored in the cache system, adds the identifier of the domain which stores the content to the content request when it is determined that the content is stored in the cache system, and forwards the content request which is added the identifier of the domain to the cache control server.

11. The cache system according to claim 10, wherein, the cache cooperation router adds the received content information to the hit determination information which manages the information of the domain identified by the identifier when receiving the content information and identifier indicating the domain which stores the content from the cache control server.

12. The cache system according to claim 9, wherein the system management server stores a hash value calculated from the identifier of the content stored in the network and management information including relationship with address of the server which manages the content information for each domain, searches management information identified by the received domain identifier when receiving a content request and the identifier of the domain in which the content from the cache cooperation router is stored, and instructs the cache control server that manages the content information to send the content to the cache server that requests the content.

13. The cache system according to claim 12, wherein, the system management server stores the content information in the management information of the domain in which the server that sent the content information is included when receiving newly stored content information from the cache control server, and sends the identifier of the domain that stores the content information to the cache cooperation router.
